(19) United States
(12) Patent Application Publication
(10) Pub. No.: US 2014/0049634 A1
(43) Pub. Date: Feb. 20, 2014

(54) SYSTEM AND METHOD FOR REMOTE CONTROL OF A MICROSCOPE

(71) Applicants: Triantafyllos P. Tafas, Rocky Hill, CT (US); Michael Thomas, West Hartford, CT (US); Youngmin Kim, Palo Alto, CA (US); Robert H. Borgerding, New Haven, CT (US); Fred C. Westphal, Madison, CT (US)

(72) Inventors: Triantafyllos P. Tafas, Rocky Hill, CT (US); Michael Thomas, West Hartford, CT (US); Youngmin Kim, Palo Alto, CA (US); Robert H. Borgerding, New Haven, CT (US); Fred C. Westphal, Madison, CT (US)

(73) Assignee: Ikonisys, Inc., New Haven, CT (US)

(21) Appl. No.: 14/063,994

(22) Filed: Oct. 25, 2013

Related U.S. Application Data
(63) Continuation of application No. 12/817,132, filed on Jun. 16, 2010, now abandoned.
(60) Provisional application No. 61/187,422, filed on Jun. 16, 2009.
(60) Provisional application No. 61/333,892, filed on May 12, 2010.

(51) Int. Cl. G02B 21/00; H04N 7/18

(52) U.S. Cl. CPC G02B 21/008; H04N 7/18
USPC 348/79

(57) ABSTRACT

A system and method for remote control of an automated microscope via a widely distributed network.

### RELATED APPLICATIONS

This application is a continuation of the patent application Ser. No. 12/817,132 filed Jun. 16, 2010. U.S. Provisional Application 61/187,422 filed Jun. 16, 2009; and U.S. Provisional Application 61/333,892 filed May 12, 2010. All related applications are incorporated herein by reference in their entirety.

### BACKGROUND OF THE INVENTION

1. Field of the Invention

The present invention generally relates to a remotely controlled automated microscope.

2. Description of the Related Art

In a conventional optical microscope, a single objective lens is used to focus on one location of a specimen carried by a microscopic slide and to acquire an image of the location. Dimensions of the image depend on the magnification and the numerical aperture of the objective lens. The image is viewed through an ocular lens or acquired through a camera. The specimen is moved and the same image-viewing process is repeated at a new location. When using these manual microscopes, the user might note the positions of interest, such as cells or nuclei of interest or fissures in metal objects, using a micrometer scale associated with the slide, thereafter using the same micrometer scales to return to the original position for further review. However, such process is slow for any application that requires a complete view of the specimen.

Other commonly used microscopes include electron microscopes, scanning probe microscopes, and scanning acoustic microscopes, all of which require different degrees of skill in their appropriate employment. The choice of microscope for a particular review entails an understanding of what needs to be elucidated. Different types of microscopy are also employed, such as (for example) bright field microscopy, confocal microscopy, dark field microscopy, fluorescence microscopy, fluorescence interference contrast microscopy, phase contrast microscopy, and laser capture microdissection, depending on what is being probed.

In order to overcome the short comings of manual microscopes, a number of companies have recently introduced automated robotic microscopes that can automatically step through fields in a slide to make a composite picture of a portion of the sample. Such systems may allow for exacting association of a position on a slide with fields comprising the composite picture.

Many microscopic examinations require significant technological skills and expensive microscopic systems that may not be readily available at the site where the microscopic information is sought. Over the years, it has become more and more common for clinicians, material engineers, and others to transmit specimens to off-site laboratories for specimen preparation and microscopic examination. While analysis at a remote microscopy laboratory run by experts in microscopic examination has significant benefits, the present inventors have recognized that it also entails a certain amount of loss in control in the review process, particularly when there is a need to question reported results or an after recognized need to probe for other conditions associated with the specimen arise.

### SUMMARY OF THE INVENTION

There is disclosed herein a remotely controlled microscopy system that allows for remote control review and/or scanning of a particular specimen slide and which may provide collaborative viewing/examination by multiple individuals of such specimen slide, who may be physically dispersed from one another. In an embodiment it also provides for remote commentary on the slide from numerous locations, and storage of such commentary on a storage medium associated with the microscope and/or microscope slide. In embodiments, the system is operatively configured to provide for real-time, simultaneous access to the images.

When laboratory technician performs original analysis on a microscope specimen in a location remote to the person seeking information about the specimen, such as a clinician, collaboration by multiple persons interested in the microscopic analysis, such as other engineers, clinicians, or researchers, entails a time consuming post examination transmission of multiple copies of an image and exchange of views by each of the reviewers. It also entails in seriatim response at the analysis site to questions which may be posed by one or more about one or more components of the image sent, or the techniques used to elucidate the image.

In a number of cases, there is a time sensitive need to understand the information gleaned from a microscopic examination. For example, physicians facing a patient in critical condition may need to understand the cause of such condition and the possible treatment modalities to reverse the critical condition. Likewise, structural engineers facing a possible catastrophic failure of a structure may need to understand immediately the condition of structure and may need to consult others on whether the structure should be closed. The present inventors have recognized that there may be the need in some cases for numerous experts to comment on a microscopy image simultaneously to meet such emergency situations. Present systems, however, do not provide for such easy collaborations unless everyone is located in the same location and has ready access to the microscopic image.

Experts may also differ on what components of an image may be significant. Thus, one expert may see a possible aberration from normalcy in a portion of an image, wherein another may not. When questions arise today, new samples are often collected and new images taken to determine whether a hypothesized aberration truly exists. There is not provided a mechanism wherein one or more investigators seeking the microscopic services of a remote location can request in real time a closer view of a specimen locus based upon a predefined image resolution. In an embodiment, the present invention overcomes such problem by allowing one or more investigator to review the microscopic examination of the specimen in real time, and to request through remote control of the microscope for more detailed examination of one or more locus of the specimen, altering parameters of the scope such as magnification and filtering.

It may be advantageous after receiving a microscopic image and making a diagnosis there from, to be able to revisit the slide in the future. In fact, regulations may require that a specimen sample on a microscope slide be archived in order to allow post-diagnosis review of a diagnostic decision. There can be advantage in having a central microscopy location which is equipped to maintain such slides in a storage environment that protects the integrity of the specimen on the slide to the greatest extent. Retrieving a single slide from many may however be a difficult task. In an embodiment, there is therefore provided a system for cataloguing a particular slide along with a particular automated microscope cassette and the position of such slide in the cassette. In such embodiment the automated microscope uses such information to automatically select the remotely requested slide from the appropriate cassette and to provide image access to the slide to the remote person seeking the same. Optionally, data storage may be associated with the slide and/or automated microscope that can be accessed by the automated microscope to concomitantly provide the image data originally associated with the slide when first probed (and/or the scanning parameter data on how such image was constructed). By comparing such original image data to any image data later obtained on the specimen, a determination of the degree of degradation of the specimen over time, if any, may be made. Retrieval of the slide may allow one to visit other areas of the slide/sample that were not part of the original scanning results, or to more closely review a portion of sample on the slide. An embodiment automated microscopy systems provides the ability to revisit a previously scanned area of a slide/sample by automatically loading and positioning the slide to the area of interest.

In an embodiment there is also provided an automated microscopy system which permits a remote investigator to test a tentative diagnosis (such as a disease state or structural integrity problem) made on the basis of image information transmitted with respect to said microscopic evaluation of the specimen on the slide by reviewing images associated with other slides in which a similar diagnosis has been made in the past. In such embodiment, the system is configured to permit request for images associated with a particular tentative diagnosis and transmission of the same to the remote investigator(s)'s site, and optionally allows the investigator(s) to seek automated comparison of such images with that obtained with respect to the investigator's own slide. For example, a review of a slide with a biological sample thereon, may suggest to an investigator that the person is inflected with schistosomiasis. The investigator may request viewing of a similar microscopic view of a similar tissue sample in which the diagnosis of schistosomiasis had been made. The investigator may request that such view be at the same magnification, through the same type of scope, using similar probes, etc. if available in the archive. The appropriate comparative image can then be transmitted for comparison by the investigator, or the investigator may request an automated comparison be made by the automated microscopy system.

In yet another embodiment there is provided an automated microscopy system comprising: at least one automated microscope comprising a stage, a microscope slide retrieval mechanism, a scanner operatively configured to generate images of a specimen at a slide placed on the stage, and a control unit configured to control slide retrieval and scanner operation; at least one server operatively connected to the at least one automated microscope, the at least one server comprising a database for storing images generated by the scanner; one or more terminals remote from the automated microscope; and at least one wide area network server connected to a widely distributed network and the at least one server, wherein the at least one wide area network server is configured to provide applications for the one or more terminals remote from said automated microscope to control through the control unit of the automated microscope slide retrieval and scanner operation and permitting receipt of images from the scanner in real time by said one or more terminals remote form the automated microscope. Optionally, the at least one server provides for a comparative image to be transmitted to said remote terminal through said wide area network server upon request from the terminal for an image thought to be related to the specimen on the slide and may comprise a module operatively configured for comparing images and information about the specimen from which the image was generated and determining comparative similarities, and further operatively configured to provide an option to the remote terminal through a wide area network server to review the comparative image when the image requested by the remote terminal is being viewed. In certain embodiments the one or more terminals remote from the automated microscope communicate through a web browser to the widely distributed network. The microscope slide retrieval mechanism of such embodiment may be operatively configured to retrieve a slide from a cassette storing a plurality of slides, as well as operatively configured to retrieve the cassette housing the slide from a plurality of cassettes.

Likewise there is provided in embodiments, a distributed computer system comprising a memory programmed with computer executable instructions operatively configured to remotely:

select and load a particular slide with material thereon in an automated microscope;

set the automated microscope for scanning;

position the particular slide for scanning;

set exposure and focus of the automated microscope;

scan the particular slide and capture an image at the exposure and focus;

and store the image of material on the particular slide in a data base.

In a further embodiment there is provided an automated microscopy system that comprises: at least one automated microscope comprising a stage, a microscope slide retrieval mechanism, a scanner operatively configured to generate images of a specimen at a slide placed on the stage, and a control unit configured to control slide retrieval and scanner operation; at least one server operatively connected to the at least one automated microscope the server comprising a database for storing images generated by the scanner; one or more terminals remote from the automated microscope; and at least one wide area network server connected to a widely distributed network and the at least one server, wherein the at least one wide area network server is configured to provide an application for retrieving an image from the database, and to process the slide associated with the image by further microscopic review by the automated microscope. The further microscopic by the automated microscope optionally may provide the ability to visits areas of the specimen on said slide that were not part of the scanning results comprising said image and/or center on previously identified areas of interest in said requested image.

There is also provided herein automated microscopy system comprising: at least one automated microscope comprising a stage, a microscope slide retrieval mechanism, a scanner operatively configured to generate images of a specimen at a slide placed on the stage, and a control unit configured to control slide retrieval and scanner operation; at least one server operatively connected to the at least one automated microscope the server comprising a database for storing images generated by the scanner; a plurality of terminals remote from the automated microscope and from one another; and at least one wide area network server connected to a widely distributed network and the at least one server, wherein the at least one wide area network server is configured to provide an application for each remote terminal to concurrently receive the same image related to a specimen on a slide, and for a user at the remote terminals to provide comment on the image in real time to other users of the remote terminals. The comment on image in real time may comprise, for example, in part identification if a particular area of interest to one or more users, and/or may comprise text. The application may further provide only one remote terminal at a time to control functions with respect to the automated microscope.

Also disclosed are methods in computer system. One such method comprises: receiving a digitally processable request from a remote location for a archived microscopic image from a microscopic image database and for further processing of the sample corresponding to the microscopic image; determining a slide housing the sample corresponding to the archived microscopic image; instructing an automated microscopy system to review the sample on the slide to form a new microscopic image;

receiving the new microscopic image; and storing the new microscopic image in the microscopic image database. The method may further comprise transmitting the image to the remote location requesting the archived microscopic image and further processing of the sample corresponding to the microscopic image. The slide may be stored in an archive, the location of which may be determined. The new microscopic image may be stored in a manner so as to be co relatable to the archived microscopic image.

A further method in a computer system is also disclosed, the method comprising: receiving a digitally processable request from a remote location for an archived microscopic image from a microscopic image database and a for further processing of the sample corresponding to the microscopic image according to one of several pre-defined protocols; determining a slide housing the sample corresponding to the microscopic image; instructing an automated microscopy system to review the sample on the slide according to the selected predefined protocol to form a new microscopic image; receiving the new microscopic image; and storing the new microscopic image in the microscopic image database. Such review of the sample is the method may entail scanning at multiple depths within the sample.

### BRIEF DESCRIPTION OF THE DRAWINGS

FIG. 1 is an exemplary block diagram of an automated embodiment microscope system providing remote operation and observation of slide specimens over various distributed networks.

FIG. 2 is an exemplar interaction diagram of the interactions between the various aspects of one embodiment of an automated microscope system.

FIG. 3a-b is an flowchart showing the steps of an embodiment of an automated microscope system.

### DETAILED DESCRIPTION OF THE INVENTION

The present invention generally relates to a system and method for remote control of an automated microscope.

The remote system and method features are a sub-system, integrated into an automated microscope system, such as can be found in the Ikonisys, Inc., Ikonisoft software system and Ikoniscope automated microscope. The system and methods herein provide the capability to remotely control an automated microscope system and capture and transmit imagery data to one or more remote workstation in real-time.

The following definitions will be found useful in describing the system and method of the present invention:

Cassette: A slide container capable of holding a plurality of slides in a non-contacting fixed position.

Channel: A combination of excitation filter, dichroic mirror, and emission filter utilized to produce fluorescent image at a given magnification.

DAPI: 4′6-diamindino-2-phenylindole-2HCl, a fluorescent probe for DNA used for nucleus visualization.

Deposition Area: An area on a slide where a sample is deposited.

Exposure Time: A time required for a camera to capture a specific signal.

Field: An area that can be pictured with a camera and given optics.

High mag: An increased magnification at which a target selected at low mag is further analyzed.

Ikonisoft.®: A proprietary software system by Ikonisys Inc.

LAN: Local Area Network

WAN: Wide Area Network

Low mag: A magnification at which target candidates are first viewed

Nucleus: A nucleus in a cell. For example, the nucleus can target to be identified at low magnification scanning and to be analyzed further at high magnification

RUO: Research Use Only

Sample Type: A type of sample, e.g. cell-suspension

Scan Level: A sequential number associated with a particular objective power at which targets are selected and analyzed. The scan level increases as the objective power increases. For example, in two scan level cases with 10.times. and 100.times., the first and the second levels correspond to low mag and high mag, respectively.

Scanner: A device for scanning slides. The scanner may be associated with an apparatus for loading/unloading cassettes.

Server: A computer system with database and database management storage for image storage and/or slide information (e.g., patient, source of specimen, date of collection, date of processing, specimen treatment before image collection). The server may be separate from the automated microscope, for example have LAN connectivity thereto.

Slice: An image of a field at a particular z distance. Usually each slice in a stack is distanced at one depth of field.

Slide: A substrate for holding specimens for analysis. A slide may be a rectangular glass plate that holds biological samples for analysis.

Slide Operator: A technician who is responsible for loading cassettes and scanning the slides.

Viewer: An application for reviewing scanned results, patient data, etc.

Operator or Investigator: a user of the system, for example (without limitation). a clinician, a researcher, a material scientist.

In one embodiment, remote microscopy provides an operator remote from the automated microscope the ability to revisit previously scanned areas of a slide/specimen. In such embodiment, the request from the remote operator causes an automated look up of the archived storage position of the requested slide at the microscopy center, and a automatic transmission for retrieval of the same. If the slides are stored in cassettes, the particular cassette may be retrieved based unique indicia associated with the cassette, for example, a bar code, an rfid read etc. The cassette is then loaded, manually or automatically, into the automated microscope, and the slide selected based upon information stored in a database as to the position of the slide within the cassette. The automatic microscope then automatically loads the slide and positions the slide with respect to the scanner/objective to such that the area of interest identified by the remote user is interrogated by the microscope. The embodiment system may provide the remote user to control the microscope at the remote location, allowing the remote user to move the field of view, the filters applied in respect of the microscopy, the magnification level of the view, the particular depth of field of the view etc.

In yet a further embodiment, the system and methods herein provide the image to multiple investigators at different locations remote from one another wherein each can see a live review of the microscopy. The system may optionally provide for input onto the image which can be viewed by all other, or select other, investigators also reviewing the image. Such input may be in real time. For example, an investigator may be allowed to position a pointer on the image to point to a position of interest to that investigator and which may be also of interest to other investigators. The automated microscope system may automatically provide a designator to such pointer designating the investigator who provided the same. The system may also provide for annotations to be provided to the image, or a pointer on the image, to allow others to view the thoughts of any investigator wishing to share the same. The system may allow for selection by a moderator of the rights provided to each of the other investigators, such as microscope control rights, annotation rights, etc.

The moderator of the scan may cause the automated microscope to scan the slide automatically sing a pre-generated protocol or may take over the automated review protocol substituting therefore manual review from the remote location. The moderator may also change slides. For example, the moderator may take control of the Explorer.™. application within the Ikoniscope microscope system. The system provides for selection and loading of a particular slide on the microscope.

For example, an investigator may send a specimen to a laboratory having a remotely controlled microscope system as described herein, requesting the specimen be prepared for analysis for a particular condition, such as chromosomal abnormality in respect of one or more chromosomes. The specimen, requiring analysis, may be deposited at the microscopy site on a slide having a unique coding tag, such as a bar code, RFID tag or some other mechanism to uniquely identify the slide, and/or to provide for storage of information with respect to the sample, the investigator sending the sample, the image obtained with respect to a scan of the sample (which may include information pertaining to the images making up the composite image, multi-layer scans made with respect to the sample, the date of the scans, the conditions/protocol employed with respect of the scan etc.). The tag when used with respect to patient specimens may also have the ability to store information regarding the patient, specimen identification, information deriving from the examination history of the patient, and/or putative examination results. Information stored may be, for example, data regarding the microscope such as microscope identifier, coordinates of locations visited, exposure, filter selection, and magnification. The tag may also store an analysis proffered by the examiner, such that the examination results will be available to a second party at a later time for comparison over time. The tag may initially only contain a unique identifier, having additional information loaded onto the tag during the examination process. For example if the remote operator examining the slide initiates an image at one zoom setting and commands the microscope to increase magnification, the microscope may log onto the tag the trace of steps taken by the operator. The logging and storage of identifying information on the tag can occur during any examination process. The information stored may relate only to a investigator during the initial examination, or may derive from a multitude of investigators during a collaboration. The system might include in the host of data stored on the slide tag those operators and observers in attendance during the viewing, and may include operators having taken action to control the microscope and thus the nature of the examination or re-examination.

In the case of re-examination of a slide by an investigator, an investigator may request that a previously examined slide be reloaded by the system for follow-up examination. The system will search the archive of slides, and cause loading of the slide, or the cassette in which the slide resides, to be loaded onto the automated microscope for examination. In an embodiment, investigators are allowed to request multiple slides for review, either sequentially, at the same time, or disparate times. To assure that the correct slide is being read, in an embodiment, the automated microscopy system is configured to read the coding tag on the slide and to automatically confirm that the appropriate slide is being read. The system may be programmed to notify by electronic communication when the slides have been obtained or are currently available for review, to allow the investigator to determine when review, or collaborative review, should be scheduled.

The investigator requesting the examination may in an embodiment set the examination protocol which the automated microscopy system is to follow. When reexamining a slide, the investigator may remotely instruct the automated microscope to scan the slide using parameters selected in a previous examination created for the slide, or to use different parameters. An application for such purpose is exemplified by the Explorer application found in the Ikonisoft.®. microscope software package. If no application was preselected, the system can offer the operator the ability to select and/or create an application protocol. The protocol may be a new protocol based on a selection of use (routines. The investigator may establish the protocol during the construction of the original request for examination/re-examination, or may establish the protocol once informed of the slides readiness for examination/re-examination. The investigator after being informed by the microscopy system of the previous examination(s) that were performed, including the protocols used, microscope settings and any of the information stored on the slide tag or by the system itself in a database, may be provided the opportunity to build a re-examination request protocol. That is, the remote investigator can re-run a previously run scan, looking for changes over time, or perform an entirely new scan.

In an embodiment, the investigator is permitted to point to a position in the image, and the system locates such position on the slide automatically to allow for further investigator of such specimen position on the slide. The requested positional scan can be augmented by a request for other scans in the microscopy system's servers, or more generally databases, that contain structure similar to what is being reviewed. For example, an investigator may be interested in whether a biological sample has indications that the person from whom the sample was taken has particular disease state associated with a cellular abnormality. At the time of reviewing the particular cellular abnormality, the investigator may request example images of other such cellular abnormalities in the systems image archive.

In some circumstances, the remote investigator may wish to compare a current slide with a slide with respect to the same source of the specimen (such as a person in respect of a biological sample, a bridge in respect of a material sample) taken at a previous time. The system may be configured to present to the investigator for potential review images from the same source, or images that may be relevant to what the investigator is searching for, to the extent that such may be provided without breaching confidentiality if such is required under the law.

In an embodiment, the system stores the locality of fields associated with the specimen on the slide, such that it can re-establish the locality of the field with respect to the specimen on the slide, allowing the remote investigator to perform any desired additional measures, including comparison of the current view to that of the previous.

A remote investigator may wish to manually control the microscope remotely. This may particularly be true if an investigator is determined to examine additional areas of the slide that were not part of a previous session protocol. With regard to controlling the microscope, and thus the slide, positioning of the specimen in any x, y, z position can be facilitated by the remote investigator using commands either entered on a command line or by selecting a command button or icon on the remote application interface. The exposure and focus settings can also be via an interactive manual command from the remote investigator or the investigator may elect to let the system automatically handle these features via the use of default settings. The default settings can be stored by the investigator at the remote location, or at a server and associated with the investigator by means of a login and password correlation, or on the slide tag itself

Embodiments permit images to be viewed live in monochrome, color, or pseudo-color mode. The pseudo-color mode can be generated to assist the operator in distinguishing slight variations in optical values of the image or the highlighting of particular features. The mode selection can be stored as previously described for the exposure and focus settings for the original interrogation of the specimen on the slide, should re-examination be requested. The user may have control over switching between several modes or may display both modes in separate windows, illustrating the broad features of the image and simultaneously the highlighted features.

In the instance where an original slide is loaded the investigator may desire to have interactive ability for image capture. A command may be given to instantiate an original slide specimen for presentation to the microscope system. The slide is loaded into the microscope via the system cassette and presented to the scanning optics. The operator is notified by the machine that the slide has been loaded. Any identifying information that might be gained from a bar code or other coding deposed on the slide can be relayed to the remote operator, such that he/she can confirm the specimen origin by a tracing back to the specimen/patient database. The operator may intentionally request confirmation of the slide/specimen/patient data by issuing a command or selecting a menu or icon intended for such purpose. The microscope system would retrieve the requested information and relay the information back to the remote operator.

Other interactive operations may be invoked by the remote user operating the microscope, such as cell and sub-cellular structure detection by calling functions selected within an application (e.g. for nucleus detection, FISH enumeration etc). The remote user may have at his/her disposal access to the complete host of manual or automated functionality by either use of a downloaded application or by way of remote calls to local application extensions that facilitate the command locally.

Image results generated from viewing or scanning the specimen are stored in a storage location for later viewing by a viewer application. The images can be viewed immediately upon scanning by one or more viewers, i.e., in real-time, or can be stored and viewed at a time more convenient for a group of viewers. During a viewing session, the system will designate the session as a new slide run; including all the necessary tracking data and viewing parameters. A log of the session can be stored such that a history of the session can be viewed or retrieved to recreate an analysis trace. Storage of the log may be maintained by the system database and associated system database management system and/or may be stored on the slide in data storage associated therewith.

Low magnification and high magnification images may be stored and linked according to a viewer protocol that is established prior to the session. The protocol can be modified by an operator or administrator based on required access rights and needs. Further storage needs include raw (unprocessed) images as commanded by the investigator operating the system: for example, with possible absence of some fluorescence channels for a particular field. The storage of some aspect during auto-detection may not be used dependent on the system preferences set by the operator or administrator.

As previously described, multiple observers may be enabled to participate in a viewing session. The local observers might be connected directly to the microscope or doing so on a workstation connected via a local area network (LAN). Remote observers might be connected via a wide area network (WAN), such as the World Wide Web. During these collaborations, selected viewers can be given operator capabilities either by an administrator or the controlling operator/physician, wherein the secondary operators can manipulate the slides position, focus, exposure, and the like. Secondary operators may be allowed some or all operator control based on a selection of previously defined tasks. For example, a secondary operator may command the microscope to use a different protocol based on his/her experience with relevant aspects of the examination, or that a different exposure would highlight aspects of the specimen not previously seen.

Multiple automated microscopes may exist within the system and be accessible to remote operators. For example, a electron microscope may be selected vs. an optical microscope. Select microscopes can be disallowed from accepting remote connections. For example, automated microscopes currently engaged in normal scanning operations can be selected to disallow remote operations. At the control of the administrator or controlling investigator in charge of the operation, secondary investigators/operators may be disallowed control and reverted to observer status during a collaboration.

The remote investigator interface provides an observer/operator interface capable of operating at the local microscope screen resolution or higher. The interface provides a mechanism for setting the state of each microscope control point, and a mechanism to display the state of each control point. The interface advantageously is protected from setting states that would damage either the slide or the microscope, or cause unnecessary bleaching of the specimen. The application for selecting the protocols may be responsible for invoking the remote operation, although other applications can be used. With the operator/observer interface multiple control points can be set and read. Each cassette can be loaded, unloaded and the unique coding read. The slides can be loaded, unloaded and the unique coding read. In addition to reading the stage (x, y) positions, the focus position (z) can be read and the shutter opened and closed from the remote location. The remote operator may in embodiments command the darkfield light to cycle on and off, and select from one of six filter wheel channels, as well as one of six objectives. Main camera gain, binning, exposure and snap/video may also be commanded by the remote operator via the remote operator/observer interface.

In embodiments, the remote operator/observer can request various algorithms be run including, for example:

Snap all enabled channels at specified settings and display a colorized image. Control shutter to minimize bleaching (Multi-channel snap).

Take a Multi-Channel Snap at multiple Z locations centered at current Z. Display a colorized image of the center image (Stack).

Display continuous Video using only the DAPI channel while motion is in progress (Video).

Find a reasonable exposure level for the current image (Auto Exposure).

Find a reasonable focus position for the current image (Auto Focus).

Move stage when objective changes to keep the image centered (Parcentricity).

Move Z when objective changes to keep the image focused (Parfocality).

Display capabilities are generally are provided at the remote operator/observer interface to aide viewing. The operator may be given the power can raise or lower the magnification of the image sample. In an embodiment if the operator/observer wishes to traverse an image stack, they can rotate the mouse wheel. Enhancement of the remote image can be performed at the remote operator/observer interface, increasing or decreasing the intensity of each channel in the display image. Furthermore, the operator/observer may be provided the option of maximizing the image to the maximum size while maintaining the aspect ratio.

Each objective may be associated with a displayable slide map showing the location and coordinates of each field on the slide. The map may support pan and zoom, and can expand to a point where a single field is displayable as a full screen image (preserving aspect ratio). Clicking on a field may recall the last image snapped at that field (if any)

In one embodiment, the remote workstation uses a web browser, such as Mozilla Firefox, or Safari to facilitate the viewing and control of the automated microscope via downloadable applications that may be written in Java, JavaScript or a variation of various programming languages. Alternatively, the implementation environment can be C# in combination with .NET 32 bit and Windows Presentation Foundation (WPF). Various scripts can also be implemented to automate various scanning protocols.

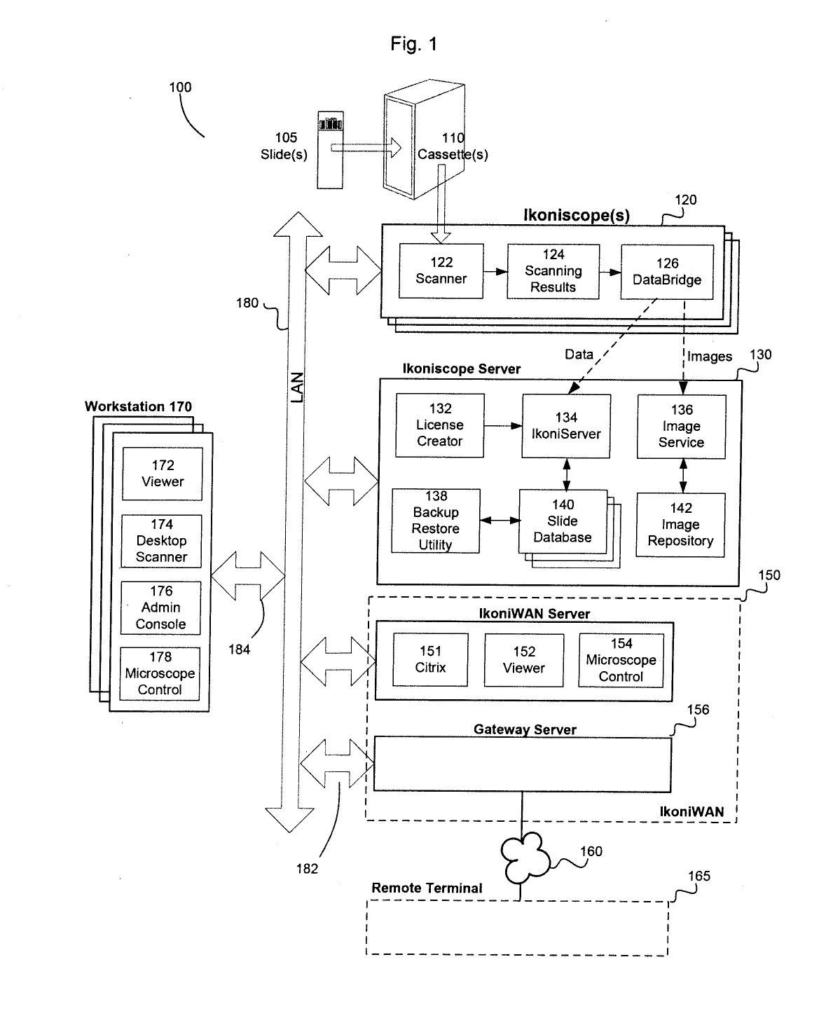

Turning to FIG. 1, there is shown an exemplary block diagram of an automated embodiment microscope system 100 providing remote operation and observation of slide specimens over various distributed networks. Slide(s) 105 are loaded into cassette 110 by an operator or automated recovery system, where the slides are archived (not shown). One of many microscope(s) 115 receives the cassette individually, as a set, or as an addition to a series of cassettes currently loaded and possibly under examination. The automated microscope(s) 120 comprise a scanner 122 producing scanner results 124 of the specimen on the slide which may be transmitted by data bridge 126 to server 130. Having accepted the cassette containing a slide of interest, the microscope will read the cassette identifying information off the unique coding tag associated with the cassette. Having worked through any preceding cassettes, the one containing the slide of interest is positioned such that the slides are drawn from the cassette and positioned in the scanning area on the slide stage (not shown). Scanner 122 will scan the microscope slide according to any protocols established by the remote operator or via remote manual control of the microscope and provide image data as well as data stored in the unique coding tag on the slide and present this scanning result 124 to the data bridge 126 so the data may be passed to data server 134 located within or associated with the microscope server 130 and an image service 136, again within or associated with the microscope server 130. Microscope server 130 may optionally comprise a license creator 132 for confirming licenses for external users of the automated microscope system, a backup restore utility 138 for backing up information gleaned from a slide, a slide database 140 storing information about the source of the specimen/sample and optionally directions for handling the specimen and its read, and an image repository 142 for storing image data derived from scanner 122. Passage of data and images from the microscope(s) 120 may be monitored and altered over a local area network 180 (having a multitude of connections 182 and 184) via one or more local workstation(s) 170, wherein such station(s) may have, for example, a viewer application 172, a optional desktop scanner application 174, an administration console application 176 allowing for administrative control over the automated microscopy functions, and a manual microscope application 178 allowing for manual control over automated microscope 120 operation.

Remote access server 150, as with the local workstation(s) 170 has a manual microscope application 154 associated with it allowing remote terminal(s) 165 to control operation functions of automated microscope 120. In addition, the remote server 150 may comprise a viewer application 152, a Citrix server 151, and a gateway server 156.

A remote terminal 165, used by a remote operator/observer is connected via a widely distributed network such as the internet 160 to the gateway server 156 of the remote access server 150 to provide access to the microscope(s) 120 functionality and offer control of the microscope(s) 120.

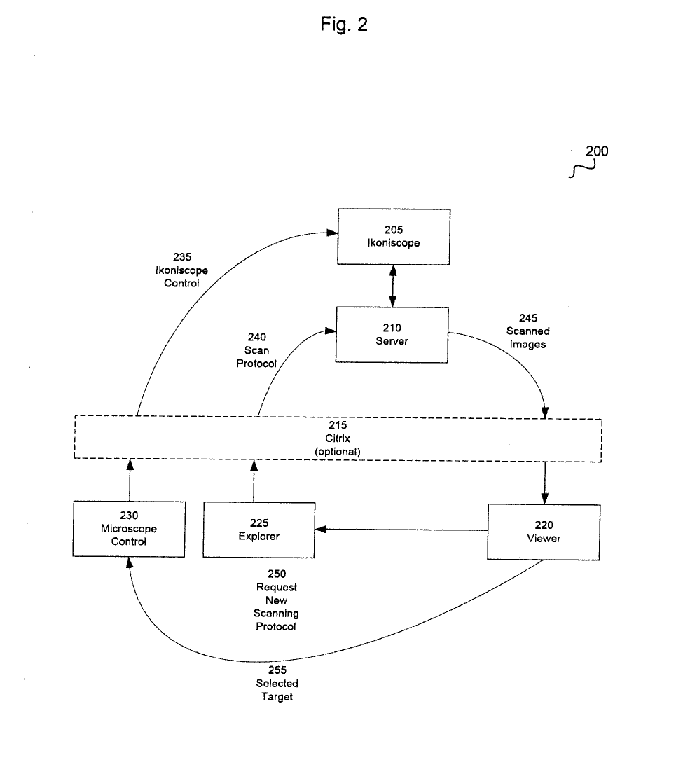

Turning to FIG. 2, there is shown an exemplar interaction diagram of the interactions between the various aspects of an exemplar system. System 200, comprises a automated robotic microscope 205, such as the Ikoniscope.®. produced and sold by Ikonisys, Inc. System 200 further comprises server 210, an implementation of Citrix 215, Viewer application 220 allowing for viewing of images from automated microscope 205, application 225 permitting selection of scan protocol and other applications, such as found the Explorer application associated with the Ikoniscope, a manual control application 230 allowing for control of image collection and review.

FIG. 2 illustrates an embodiment system 200. Remote user can view images form automated microscope 205 and select a protocol for microscopic review of a slide via application 225 or manual control of the scope via manual control application 230 through an implementation of Viewer 220. The selection would be sent as a control instructions 235 to automated microscope 205 to retrieve an image and related data. Viewer 220 may be used to select a particular target 255 in an image for further more detailed review, with a selection as to processing being selected from application 225 or manual processing being selected via manual control application 230. Investigator can use the Explorer application 225 to create a new protocol 240 or search and select a protocol that has previously been run on the slide of interest, or created and run on another slide or just saved for later use. Explorer application 225 presents to the investigator an interface for facilitating his/her selection. Such an interface could be via Viewer 220.

In combination with the images and data from the microscope 205, server 210 makes available the scanned images 245 to the viewer 220.

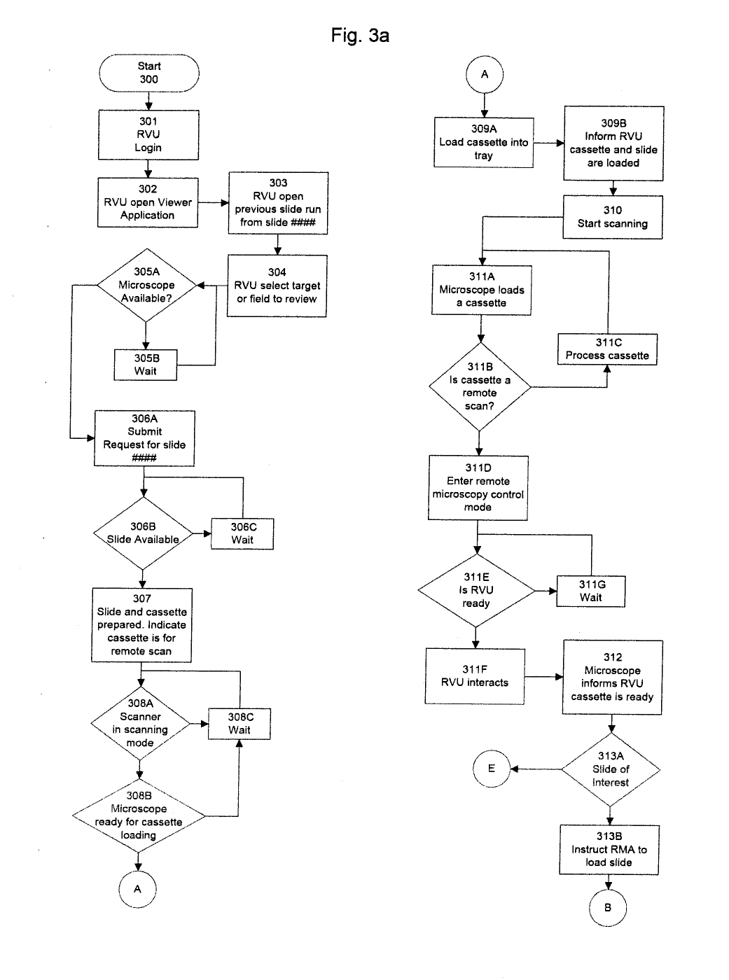

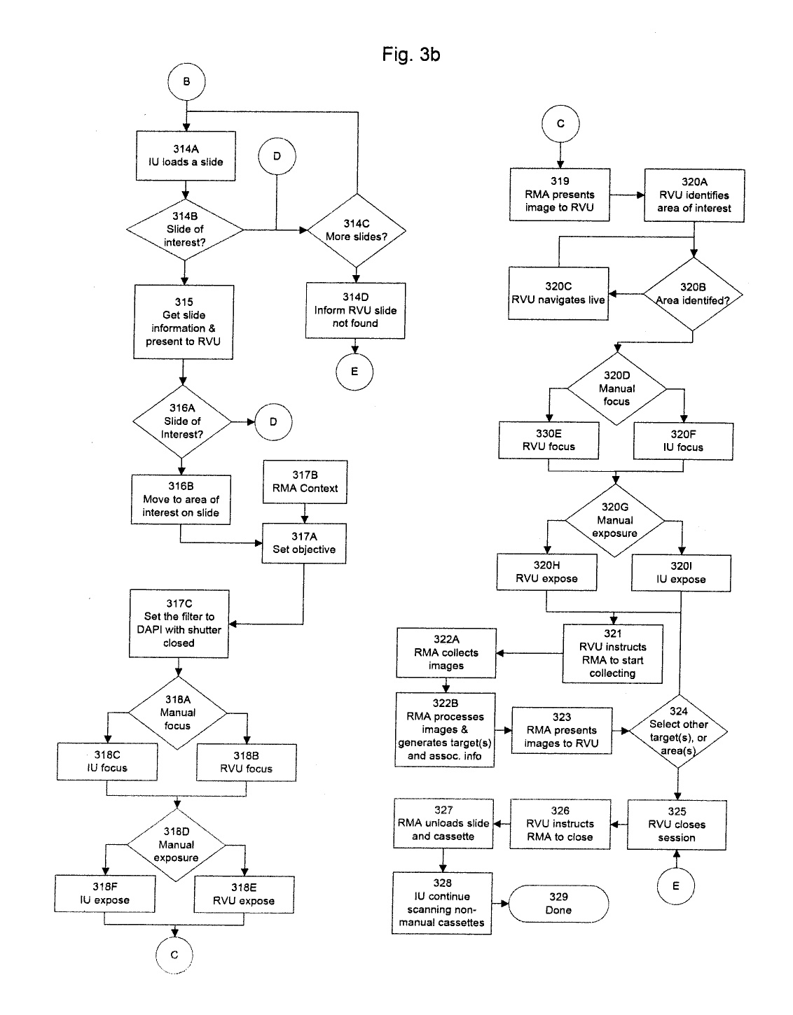

FIG. 3a-b, shows a flow chart of one embodiment of the present invention. In this embodiment, an investigator is identified as a Remote Viewer User (RVU). The remote application used by the RVU is defined as a Remote Microscopy Application (RMA). An operator local to the microscope system and responsible for assisting with any operations, such as the system administrator, is identified as an Ikoniscope Operator (IO). The microscope system itself is identified in this embodiment as the Ikoniscope Unit (IU).

The remote microscopy system starts at step 300. The RVU, at step 301, logs into remote access server 150 to gain access to the RMA and scan or examine the specimens of interest. The RVU opens, at step 302, the Viewer application 172 so the remote investigator may browse and select a previous slide run. RVU opens, at step 303, a previous slide run from slide ### out of a possible multitude of slides and slide runs. The slides and slide runs may be browsed by sorting by various criteria or searched via a search engine (not shown). RVU selects, at step 304, a target or field to review live through the RMA. At step 305A-B, the RVU finds out if the IU at the remote site is available for live review and may wait until such time it becomes available. Because a previous slide examination can be tied to a particular IU, the RVU may elect that subsequent examinations may be associated with that IU. The RVU may elect to use an alternative unit for any number of reasons, such as time, capabilities.

At step 306A-B, RVU contacts the JO and tells them (s)he wants to see the slide ### live. The IO prepares, at step 307, the slide and the cassette and indicates the cassette is for manual scan. The IO makes sure, at step 308A-C the scanner 122 is not in scanning mode and is ready for new cassettes 110 to be loaded. If either the scanner 122 or microscope is not ready the system will wait. At step 309A-B, the IO loads the cassette into the tray, contacts the RVU and inform them the slide and the cassette are ready for scanning. After loading the requested slide/cassette, the IO could load additional cassettes that might be controlled locally or might satisfy the request of a second or additional request by a different party/person, thereby keeping the use of the microscope optimized.

At step 310, the scanning is started. The scanning may be initialed by actions taken local to the microscope system during or after loading of the cassette. Alternatively, the scanning may be initiated by the RVU issuing a command from the remote terminal 165 that directly or indirectly causes the action. In the present embodiment, once the scanning is started the IU, at steps 311A-G, starts loading cassette(s) such that when the cassette 110 with the requested slide 105 is encountered, the IU goes into an RMA mode, step 311D, and waits for RVU interaction. The cassette is queried, step 311B, to determine if it is the cassette for the remote scanning. If not, the cassette is processed, step 311C, as would be done locally or by means not under the control of the present RVU. After entering the RMA mode, step 311D, the system will query, step 311E, the RVU to determine if (s)he is ready. If not, the system, at step 311G, will wait. Interaction by the RVU, step 311F, determines the state of readiness and allows the process to continue.

The RVU, at step 312, gets informed by the RMA that the manual cassette is loaded and ready for manual slide scan. If the RVU verifies, at step 313A-B, the current slide is the slide of interest, step 313A, the RVU will instruct, at step 3138, the RMA to load the slide. The RMA, at steps 314A-D, starts loading slide(s) until it encounters the slide of interest or RMA warns the RVU if it fails to find the slide of interest. If the slide is not found the RVU can close the session as described further below, or issue a new request (not shown).

At step 315 the RMA retrieves the slide information, such as a barcode, application, deposition area, etc, and the presents the information to the RVU. The slide information can be drawn by correlating the coded information on the slide to a databases within the system. As previously described, additional information relevant to the specimen, such as a examination log, may be stored on a unique coded tag deposited on the slide itself. Such a tag can be, for example an RFID tag or some other coding/storage device that can be associated with the specimen of interest.

The RVU verifies, at steps 316A-B, the info and instructs the RMA to move the slide to the area of interest. The RMA sets, at steps 317A-C, the microscope to the proper objective determined by the context where RMA is invoked in the Viewer and sets the filter to DAPI with the shutter closed. The RVU then decides, at steps 318A-F, whether to focus and expose manually or automatically, and perform the operation. Once exposed, the RMA presents, at step 319, the static field image to the RVU. The RVU, at steps 320A-I, identifies the target or area of interest and if the area is not identified, the RVU is allowed to manually navigate the slide live until (s)he finds the target or area. Focus and exposure opportunities are once again offered to the RVU where the can elect to perform them manually or automatically.

Having exposed the target area, the RVU, at steps 321, tells RMA to start collecting images from the field. Images are collected and processed, steps 322A-B, by the RMA generating target(s) and associated information. At step 323, the RMA presents the results to the RVU. If the RVU, at step 324, wants to select other target(s) or area(s), the RVU may repeat the instruction to start collecting, at step 321.

When the remote operation is deemed complete, by either gathering the data and having performed sufficient scanning or collaboration, or the RVU fails to find the slide of interest and wishes to end the session, the RVU, at step 325, explicitly closes the new slide run session. The RVU instructs, at step 326, the RMA to close, where the RMA, at step 327 unloads the slide and unloads the cassette from the microscope system. If additional cassettes are in the queue, then at step 328, the IU continues scanning the rest of the non-remote cassette(s) if loaded and is done at step 329.

### Statement Regarding Preferred Embodiments

While the invention has been described with respect to preferred embodiments, those skilled in the art will readily appreciate that various changes and/or modifications can be made to the invention without departing from the spirit or scope of the invention as defined by the appended claims. All documents cited herein are incorporated by reference herein where appropriate for teachings of additional or alternative details, features and/or technical background.

1.-20. (canceled)

21. A system of remote automated microscopy with manual control access comprising:
at least one automated microscope remotely and multiply accessible servers comprising,
an electronically connected and controlled by a computer system comprising multiply accessible servers, a stage, a microscope slide retrieval mechanism, a digital scanner operatively configured to generate images of a bright field stained or/and a fluorescently labelled and location marker identifiable specimen mounted on a slide placed on said stage, and a control unit programmed to control slide retrieval and scanner operation;
said computer system comprising a memory programmed with computer executable instructions operatively configured to remotely select and load a particular slide from an electronically controlled cassette holding one or more than one slide with a colorimetric and/or fluorescent stained specimen thereon in an automated microscope; set the automated microscope for scanning; position the particular slide for scanning; set exposure and focus of the automated microscope; scan the particular slide and capture an image at the exposure and focus; and store the image of the specimen and mark a relevant barcode on the particular slide or a sequence of the slides in a data base;
a remote investigator switches into one of the multiple remote access servers comprising an image storage database to gain access to the remote one or more than one microscope in said microscopy system, and to optionally manually manipulate or electronically initiate a programmed scan to examine at least one specimen of interest on said one or more than one slide assorted to one or more slide holding cassette;
remotely sorting by various criteria or searching via a search engine a target or field on said slide live through the automated microscopy process; calling up at least one cassette containing the at least one specimen slide which is prepared for an automated or a manual scan when a scanner or microscope is ready; selecting said slide in said cassette and scanning said selected slide; providing a signal of readiness before continuing the process of selecting another slide; said selection defines coded specimen identity or slide information via a barcode, or deposition area, correlating the coded information carried on a unique tag deposited on said slide to said database; wherein said tag can be an RFID other coding/storage device associated with the specimen of interest;
wherein the remote investigator verifies the information and instructs the remote microscope application system after exposure and photographic image transmission to said database while remotely moving the microscope objective to next coded slide field of interest continuing the investigation of the stored specimen.
